(19) United States
(12) Patent Application Publication
(10) Pub. No.: US 2026/0299925 A1
(43) Pub. Date: Oct. 1, 2026

(54) SOFTWARE UPDATE SYSTEM, VEHICLE, SOFTWARE UPDATE DEVICE, AND SOFTWARE UPDATE METHOD

(71) Applicant: HONDA MOTOR CO., LTD., Tokyo (JP)

(72) Inventors: Yasumasa Kaitani, Tokyo (JP); Yujiro Komiyama, Tokyo (JP)

(21) Appl. No.: 19/564,757

(22) Filed: Mar. 12, 2026

(30) Foreign Application Priority Data
Mar. 27, 2025 (JP) 2025-054078

(51) Int. Cl. G06F 8/65

(52) U.S. Cl. CPC G06F 8/65

(57) ABSTRACT

A software update system includes: a vehicle including an electronic control unit; and a server device capable of communicating with the vehicle, wherein the vehicle includes a software update unit that performs update of software of the electronic control unit, and a battery that supplies electric power to the electronic control unit, and wherein the software update unit transmits first information inquiring presence or absence of information related to the update of the software to the server device, receives second information including update software from the server device, and acquires, based on the second information received, a required time for an activation process of the update software, and determines, based on the required time acquired and remaining electric power of the battery, whether or not to make a transition to the activation process.

### INCORPORATION BY REFERENCE

The present application claims priority under 35 U.S.C. § 119 to Japanese Patent Application No. 2025-054078 filed on Mar. 27, 2025. The content of the application is incorporated herein by reference in its entirety.

### BACKGROUND OF THE INVENTION

### Field of the Invention

The present invention relates to a software update system, a vehicle, a software update device, and a software update method.

### Description of the Related Art

A technique for updating software in a vehicle including a battery has conventionally been known. For example, Japanese Patent Laid-Open No. 2022-054890 discloses a technique for updating a program by using a low-voltage battery when reprogramming can be performed by using a low-voltage battery and updating the program by using a high-voltage battery when reprogramming cannot be performed by using a low-voltage battery.

In update of software in vehicles, it is common practice to perform an activation process of update software. Conventional transition determination to this activation process is made based on whether or not the battery of the vehicle has enough remaining electric power for the activation process. However, a threshold value of the remaining electric power that establishes whether or not a transition to the activation process is to be made is a threshold value corresponding to a fixed required time for the activation process. Therefore, even if the remaining electric power is sufficient for an actual required time for the activation process, determination not to make a transition to the activation process may be made due to the remaining electric power being equal to or lower than the threshold value, and update of software may not be performed in some cases.

An object of the present invention, which has been made in view of the above circumstances, is to enable increasing the possibility of performing update of the software.

### SUMMARY OF THE INVENTION

One aspect of the present invention is a software update system including: a vehicle including an electronic control unit; and a server device capable of communicating with the vehicle, wherein the vehicle includes a software update unit that performs update of software of the electronic control unit, and a battery that supplies electric power to the electronic control unit, and wherein the software update unit transmits first information inquiring presence or absence of information related to the update of the software to the server device, receives second information including update software from the server device, acquires, based on the second information received, a required time for an activation process of the update software, and determines, based on the required time acquired and remaining electric power of the battery, whether or not to make a transition to the activation process.

According to one aspect of the present invention, the possibility of performing update of software can be increased.

### BRIEF DESCRIPTION OF THE DRAWINGS

FIG. 1 is a diagram showing the configuration of a software update system;

FIG. 2 is a diagram showing the configuration of a server device;

FIG. 3 is a diagram showing the configuration of a vehicle;

FIG. 4 is a sequence diagram showing the operation of the software update device and the server device;

FIG. 5 is a flowchart showing the operation of a software update unit; and

FIG. 6 is a flowchart showing the operation of the software update unit.

### DETAILED DESCRIPTION OF THE INVENTION

### 1. Configuration of Software Update System

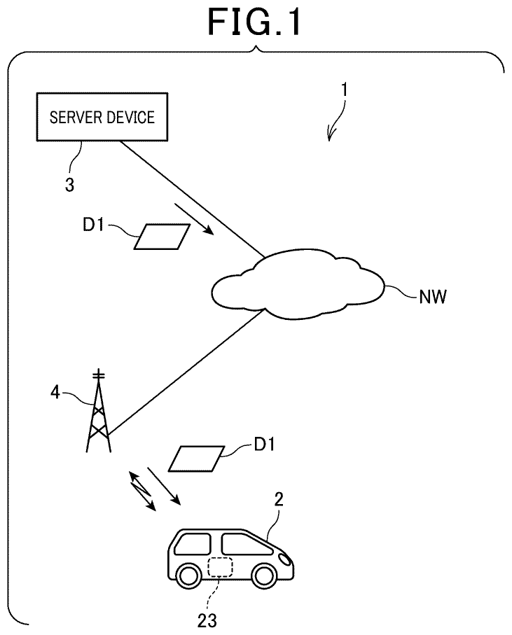

FIG. 1 is a diagram showing the configuration of a software update system 1.

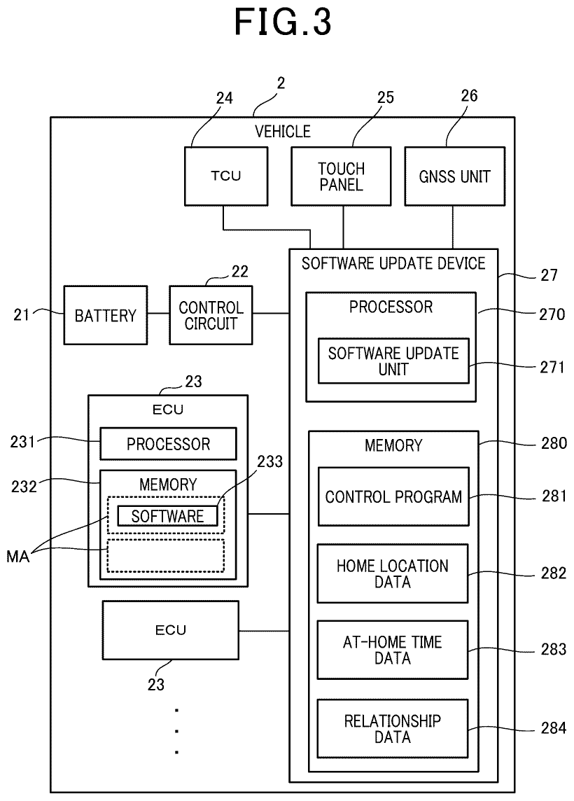

The software update system 1 includes a vehicle 2 and a server device 3 that provides software 233 (see FIG. 3) to be executed by an electronic control unit (ECU) 23 owned by the vehicle 2. The vehicle 2 and the server device 3 are communicatively connected to the vehicle 2 through a communication network NW. The vehicle 2 downloads software for update (hereinafter, with a reference sign “D1” attached thereto, expressed as update software D1) from the server device 3 and updates the software 233 owned by the ECU 23. That is, the software update system 1 enables over-the-air (OTA) update of the software 233 of the vehicle 2.

The ECU 23 is an example of “electronic control units”.

In the following description, the term software includes programs to be executed by a processor and data that is referenced, generated, updated, deleted, and the like in relation to the programs. The expression updating software refers to a process of replacing software to be executed by the processor with software of a newer version, which may be achieved in any specific way that includes addition, deletion, and overwriting of the software. Updating the software may also include processes of deleting some or all of the software to be executed by the processor, installing new software, and deleting, adding, and overwriting data used in the execution of software.

The vehicle 2 may be any of a four-wheeled vehicle, a two-wheeled vehicle, and other vehicles, or may be a heavy-duty vehicle, a commercial vehicle, a working vehicle, or the like. As an example, this embodiment describes a four-wheeled vehicle. The vehicle 2 is connected to the communication network NW by wireless communication via, for example, a base station 4 of cellular communication. The specific form of the communication network NW is not limited. For example, the communication network NW may include a cellular communication network, the Internet, a wide area network (WAN), a local area network (LAN), a public network, a provider device, a dedicated line, a base station, and the like.

The server device 3 is a computer connected to the communication network NW via a wired communication line or a wireless communication line and communicatively connected to the vehicle 2. The server device 3 transmits the update software D1 to the vehicle 2.

### 2. Configuration of Server Device

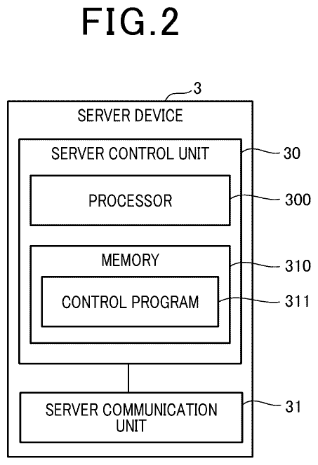

First, with reference to FIG. 2, the configuration of the server device 3 will be described.

FIG. 2 is a diagram showing the configuration of the server device 3.

The server device 3 includes a server control unit 30 and a server communication unit 31.

The server control unit 30 includes a processor 300, such as a central processing unit (CPU), a memory 310, and an interface circuit for connecting other devices and sensors. The server control unit 30 connects with the server communication unit 31. The server control unit 30 reads and executes a control program 311 stored in the memory 310 to perform various operations.

The memory 310 is a storage device storing programs and data. The memory 310 stores the control program 311, data to be processed by the processor 300, and the like. The memory 310 has a nonvolatile storage area. The memory 310 also has a volatile storage area and constitutes a working area for the processor 300. For example, the memory 310 is implemented by a read only memory (ROM) or a random access memory (RAM).

The server communication unit 31 includes hardware such as a communication circuit and communicates with the vehicle 2 as controlled by the server control unit 30.

### 3. Configuration of Vehicle

FIG. 3 is a diagram showing the configuration of the vehicle 2.

The vehicle 2 includes a battery 21, a control circuit 22, a plurality of ECUs 23, a telematics control unit (TCU) 24, a touch panel 25, a global navigation satellite system (GNSS) unit 26, and a software update device 27.

The battery 21 supplies electric power to respective units of the vehicle 2, such as the ECUs 23 and equipment controlled by the ECUs 23 to be described later. The battery 21 connects with the control circuit 22 and is controlled in electric power supply, charging, and the like by the control circuit 22. The control circuit 22 controls the electric power supply of the battery 21 as controlled by the software update device 27.

The ECUs 23 are electronic control devices that control equipment provided in the vehicle 2 and connect to the software update device 27. Examples of equipment controlled by the ECUs 23 include equipment that operates the wipers of the vehicle 2, equipment that turns the lights of the vehicle 2 on and off, and a drive motor that serves as the driving source of the vehicle 2. Each ECU 23 includes a processor 231, such as a CPU, and a memory 232, and controls the connected equipment by the processor 231 reading and executing the software 233 stored in the memory 232.

The memory 232 is a storage device storing programs and data. The memory 232 stores the software 233 and data to be processed by the processor 231. The memory 232 is a double bank memory (so-called 2-sided ROM). The memory 232 has a volatile storage area and may constitute a working area for the processor 231.

The TCU 24 is a communication device that conforms to the communication standard of the vehicle 2 and communicates with devices other than the vehicle 2. The TCU 24 includes, for example, an antenna, a transmitter, a receiver, and the like, and communicates with the server device 3 as controlled by the software update device 27.

The touch panel 25, which is composed of a display and a touch sensor, accepts a touch operation and displays various types of information.

The GNSS unit 26 determines the current location of the vehicle 2. The GNSS unit 26 generates location data indicating the current location of the vehicle 2 and outputs the generated location data to the software update device 27.

The software update device 27 is a device that updates the software 233 of the ECUs 23. The software update device 27 includes a processor 270, such as a CPU, a memory 280, and an interface circuit for connecting other devices and sensors.

The memory 280 is a storage device storing programs and data. The memory 280 stores control program 281, home location data 282, at-home time data 283, relationship data 284, data to be processed by the processor 270, and the like. The memory 280 has a nonvolatile storage area. The memory 280 also has a volatile storage area and constitutes a working area for the processor 270. For example, the memory 280 is implemented by a ROM and a RAM.

The control program 281 is a program that causes the processor 270 to function as a functional unit to be described later.

The home location data 282 is data indicating the location of the home of the user of the vehicle 2 (hereinafter, referred to as home location), and indicates, for example, the latitude and longitude of the home location.

The at-home time data 283 is data indicating a time during which the user of the vehicle 2 is at home (hereinafter, referred to as at-home time), and indicates one or more at-home times. The at-home time indicated by the at-home time data may be indicated by a clock time or may be indicated by a time zone. The at-home time indicated by the at-home time data may be a time set by the user of the vehicle or may be a predetermined time.

The relationship data 284 is data indicating the relationship between the remaining electric power of the battery 21 in a case where the vehicle 2 is at the home location in the at-home time (hereinafter, referred to as “home-location remaining electric power”) and the time from when the ignition power source of the vehicle 2 is turned off until the ignition power source is turned on next time (hereinafter, referred to as “next ON time”). More specifically, the relationship data 284 is data indicating the trend of the amounts of the home-location remaining electric power and the lengths of the next ON time.

The processor 270 executes the control program 281 to thereby function as a software update unit 271.

The software update unit 271 updates the software 233 owned by the ECU 23. The software update unit 271 performs a process of inquiring presence or absence of information related to update of the software 233, a process of downloading the update software D1, a process of installing the update software D1 onto the target ECU 23, and a process of causing the ECU 23 to perform the activation process of the update software D1.

The software update unit 271 also learns the relationship between the home-location remaining electric power and the next ON time. Hereinafter, this learning by the software update unit 271 will be described in detail.

The software update unit 271 determines, in a case where the ignition power source of the vehicle 2 has been turned off, whether or not the location of the vehicle 2 is the home location. The software update unit 271 determines that the location of the vehicle 2 is the home location in a case where the current location indicated by the location data received from the GNSS unit 26 is within a predetermined distance from the home location indicated by the home location data 282.

Next, the software update unit 271 determines, in a case where determination that the location of the vehicle 2 is the home location has been made, whether or not the timing when the ignition power source of the vehicle 2 has been turned off corresponds to the at-home time. In a case where the clock time at which the ignition power source has been turned off corresponds to the at-home time indicated by the at-home time data 283, the software update unit 271 determines that the timing when the ignition power source has been turned off is the at-home time. For example, assume that the at-home time indicates a time zone of “19:00 to 07:30”. In a case where the timing when the ignition power source has been turned off is “19:10”, the software update unit 271 determines that the timing when the ignition power source has been turned off corresponds to the at-home time. On the other hand, in a case where the timing when the ignition power source has been turned off is “18:45”, the software update unit 271 determines that the timing when the ignition power source has been turned off does not correspond to the at-home time.

In a case where the timing when the ignition power source has been turned off corresponds to the at-home time, the software update unit 271 acquires, as the home-location remaining electric power, the remaining electric power of the battery 21 at the timing when the ignition power source has been turned off. The software update unit 271 may acquire the remaining electric power of the battery 21 from the control circuit 22, or may directly detect the voltage or current of the battery 21 to acquire the remaining electric power of the battery 21.

The software update unit 271 determines whether or not the ignition power source has been turned off. In a case where the software update unit 271 determines that the ignition power source has been turned off, the software update unit 271 compares the timing when the ignition power source has been turned off last time with the timing when the ignition power source has been turned on this time, to thereby acquire the next ON time.

Next, the software update unit 271 learns, based on the acquired home-location remaining electric power and the acquired next ON time, the relationship between the home-location remaining electric power and the next ON time. In this embodiment, the expression learning the relationship between the home-location remaining electric power and the next ON time means reflecting the acquired home-location remaining electric power and the acquired next ON time to the relationship data 284. The software update unit 271 reflects, using a predetermined statistical method, the acquired home-location remaining electric power and the acquired next ON time to the relationship data 284.

### 4. Operation

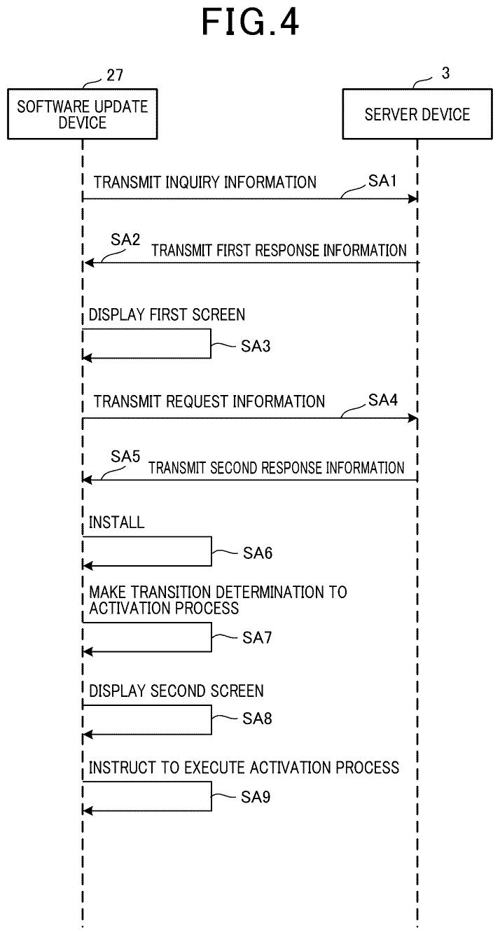

Next, with reference to FIG. 4, the operation related to the update of the software 233 of each unit of the software update system 1 will be described.

FIG. 4 is a sequence diagram showing the operation of the software update device 27 and the server device 3.

The software update unit 271 transmits inquiry information via the TCU 24 to the server device 3 (step SA1), the inquiry information inquiring presence or absence of information related to the update of the software 233.

The inquiry information is an example of “first information”.

Upon receiving the inquiry information via the server communication unit 31, the server control unit 30 transmits first response information to the vehicle 2 (step SA2).

The first response information is information indicating a response to the information transmission from the vehicle 2 and information indicating presence or absence of information related to the update of the software 233.

The software update unit 271 receives the first response information via the TCU 24, and displays, in a case where the received first response information indicates presence of the update of the software 233, on the touch panel 25 a first screen (step SA3).

The first screen is a screen that inquires the user of the vehicle 2 whether or not to perform update of the software 233. This inquiry to the user is made as required. For example, in the case of software update for the purpose of defect measures, the update may be performed without inquiring the user.

Upon instructed to perform update of the software 233 on the first screen, the software update unit 271 transmits, via the TCU 24, request information requesting the update software D1 to the server device 3 (step SA4).

Upon receiving the request information via the server communication unit 31, the server control unit 30 transmits second response information to the vehicle 2 (step SA5).

The second response information is an example of “second information”.

Here, the second response information will be described in detail.

The second response information is information indicating a response to the information transmission from the vehicle 2 and includes one more pieces of update software D1.

The second response information also includes, for each piece of update software D1, information indicating the amount of data of the update software D1.

In a case where the second response information includes a plurality of pieces of update software D1 and the order of applying the pieces of update software D1 to the ECU 23 (hereinafter, referred to as application order) is specified, the second response information also includes information indicating the application order.

Upon receiving the second information from the server device 3, in other words, upon downloading the update software D1 from the server device 3, the software update unit 271 installs the downloaded update software D1 onto the target ECU 23 (step SA6).

To describe step SA6 in detail, the software update unit 271 transfers the update software D1 to the target ECU 23 and instructs the target ECU 23 to write the update software D1 to the memory 232.

As described above, the memory 232 provided in the ECUs 23 is a double bank memory. This enables the ECUs 23 to operate according to the software 233 stored in one storage area MA of the memory 232 while writing the update software D1 to the other storage area MA of the memory 232. Accordingly, the ECUs 23 can write the update software D1 to the memory 232 even when, for example, the vehicle 2 is traveling.

Next, the software update unit 271 determines whether or not to make a transition to the activation process of the update software D1 at the timing when the ignition power source of the vehicle 2 is turned off (step SA7). This transition determination will be described in detail in a flowchart described below.

In a case where the software update unit 271 has determined to make a transition to the activation process, the software update unit 271 displays on the touch panel 25 a second screen (step SA8).

The second screen in a screen that inquires whether or not to start the update of the software 233.

Upon instructed to start the update of the software 233 on the second screen, the software update unit 271 instructs the ECU 23 whose software 233 is to be updated to execute the activation process (step SA9). In this embodiment, in relation to the activation process, the required time for the activation process is set. After the activation process starts, the vehicle 2 cannot be used during the set required time for the activation process.

Here, the activation process in the ECU 23 will be described.

Upon receiving the instruction to execute the activation process, the ECU 23 performs the activation process of the update software D1. The activation process of the update software D1 includes a process of setting, at the start-up of the ECU 23, startup parameters of the ECU 23 so that the written update software D1 is loaded and control according to the update software D1 is started. For example, the activation process of the update software D1 includes a process of enabling, as a readout area, the storage area MA in which the update software D1 is written and disabling, as a readout area, the storage area MA in which the update software D1 is not written.

In the sequence shown in FIG. 4, in a case where the software update unit 271 receives the first response information from the server device 3, the software update unit 271 may skip the process of step SA3 and perform the process of step SA4. In the software update system 1, the processes of steps SA2, SA3, and SA4 may also be skipped. In other words, the software update unit 271 may be configured to receive the second response information on the basis of transmission of the inquiry information as a trigger.

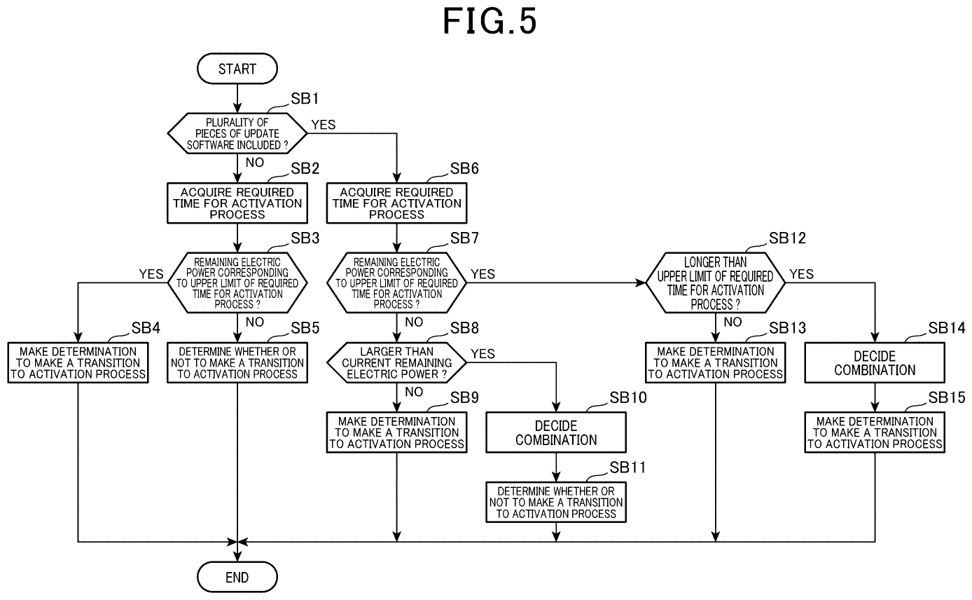

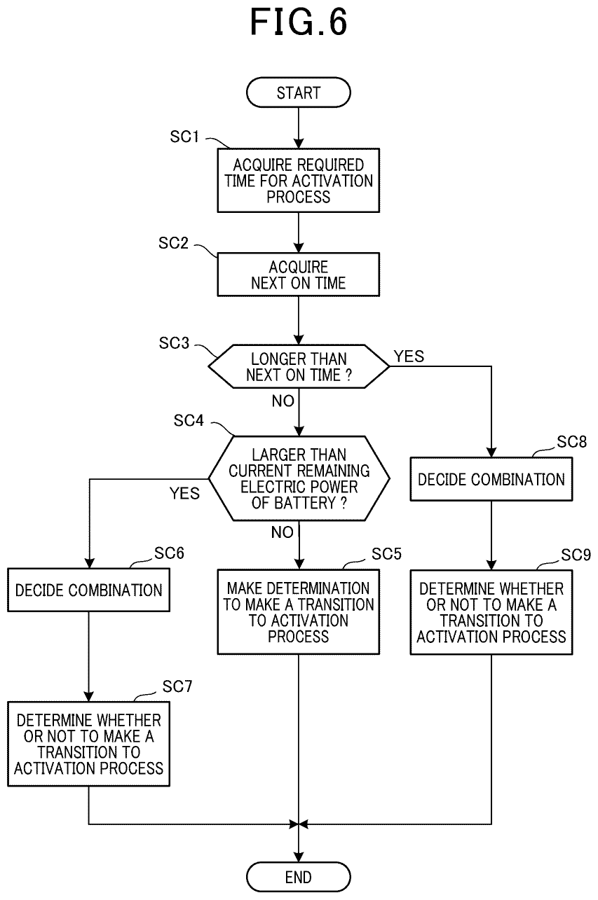

Next, with reference to FIGS. 5 and 6, the operation related to the transition determination to the activation process of the software update unit 271 will be described.

First, description is provided about the operation of the case where the location of the vehicle 2 when the ignition power source has been turned off is not the home location or the case where the timing when the ignition power source has been turned off is not the at-home time.

FIG. 5 is a flowchart showing the operation of the software update unit 271. The flowchart in FIG. 5 is the operation to be started in the case where the location of the vehicle 2 when the ignition power source has been turned off is not the home location or the case where the timing when the ignition power source has been turned off is not the at-home time.

The software update unit 271 determines whether the received second information includes a plurality of pieces of update software D1 (step SB1).

In a case where the software update unit 271 has determined that the second information does not include a plurality of pieces of update software D1 (step SB1: NO), the software update unit 271 acquires the required time for the activation process on the basis of the second information (step SB2).

Step SB2 will be described in detail.

The software update unit 271 refers to the information indicating the amount of data included in the second information to acquire the required time for the activation process. For example, the software update unit 271 acquires the required time for the activation process using an algorithm in which the calculated required time for the activation process is longer as the amount of data is larger. The required time calculated by this algorithm is a time not longer than a predetermined upper limit (for example, 600 seconds).

Acquisition of the required time for the activation process is not limited to acquisition by the algorithm. If the second information includes information indicating the required time for the activation process, the software update unit 271 may acquire the required time for the activation process from the second information.

The software update unit 271 determines whether or not the current remaining electric power of the battery 21 is equal to or larger than the remaining electric power corresponding to the upper limit (for example, 600 seconds) of the required time for the activation process (step SB3).

In a case where the software update unit 271 has determined that the current remaining electric power of the battery 21 is equal to or larger than the remaining electric power corresponding to the upper limit of the required time for the activation process (step SB3: YES), the software update unit 271 determines to make a transition to the activation process (step SB4).

In a case where the process of step SB4 is performed, the required time for the activation process that has been acquired in step SB2 is set as the actual required time for the activation process. In other words, the vehicle 2 cannot be used from the start of the activation process until the elapse of the required time for the activation process acquired in step SB2.

On the other hand, in a case where the software update unit 271 has determined that the current remaining electric power of the battery 21 is lower than the remaining electric power corresponding to the upper limit of the required time for the activation process (step SB3: NO), the software update unit 271 determines whether or not to make a transition to the activation process on the basis of the acquired required time for the activation process and the current remaining electric power of the battery 21 (step SB5).

Step SB5 will be described in detail.

The software update unit 271 acquires the remaining electric power of the battery 21 corresponding to the required time for the activation process acquired in step SB2. The software update unit 271 acquires, based on a predetermined algorithm, the remaining electric power of the battery 21 corresponding to the required time for the acquired activation process. This predetermined algorithm is an algorithm in which the calculated remaining electric power of the battery 21 is larger as the acquired required time for the activation process is longer.

Next, the software update unit 271 determines whether or not the acquired remaining electric power of the battery 21 (the remaining electric power of the battery 21 corresponding to the required time for the activation process) is equal to or lower than the current remaining electric power of the battery 21. In a case where the software update unit 271 has determined that the acquired remaining electric power of the battery 21 is equal to or lower than the current remaining electric power of the battery 21, the software update unit 271 determines to make a transition to the activation process. On the other hand, in a case where the acquired remaining electric power of the battery 21 is larger than the current remaining electric power of the battery 21, the software update unit 271 determines not to make a transition to the activation process.

In a case where determination to make a transition to the activation process has been made in step SB5, the required time for the activation process that has been acquired in step SB4 is set as the actual required time for the activation process.

Returning to the description of step SB1, in a case where the software update unit 271 has determined that the received second information includes a plurality of pieces of update software D1 (step SB1: YES), the software update unit 271 acquires, for each piece of update software D1 included in the second information, the required time for the activation process (step SB6). The acquisition in step SB6 is performed similarly to step SB2.

Next, the software update unit 271 determines whether or not the current remaining electric power of the battery 21 is equal to or larger than the remaining electric power corresponding to the upper limit of the required time for the activation process (step SB7).

In a case where the software update unit 271 has determined that the current remaining electric power of the battery 21 is lower than the remaining electric power corresponding to the upper limit of the required time for the activation process (step SB7: NO), the software update unit 271 determines whether or not the remaining electric power of the battery 21 corresponding to the sum of the required times that has been acquired in step SB6 is larger than the current remaining electric power of the battery 21 (step SB8).

In a case where the software update unit 271 has determined that the remaining electric power of the battery 21 corresponding to the sum of the required times that has been acquired in step SB6 is not larger than the current remaining electric power of the battery 21 (step SB8: NO), that is, in a case where the current remaining electric power of the battery 21 can meet the application of a plurality of pieces of update software D1, the software update unit 271 determines to make a transition to the activation process (step SB9).

In a case where the process of step SB9 is performed, the sum of the required times for the activation process that has been acquired in step SB6 is set as the actual required time for the activation process.

Returning to the description of SB8, in a case where the software update unit 271 has determined that the remaining electric power of the battery 21 corresponding to the sum of the required times that has been acquired in step SB6 is larger than the current remaining electric power of the battery 21 (step SB8: YES), the software update unit 271 decides the combination of the pieces of update software D1 that are allowed to make a transition to the activation process (step SB10).

Next, step SB10 will be described with examples.

In an example of description of step SB10, it is assumed that the second information includes first update software D1, second update software D1, and third update software D1.

In addition, in the example of description of step SB10, it is assumed that the required time for the activation process in relation to the first update software D1 is “A seconds”, the required time for the activation process in relation to the second update software D1 is “B (>A) seconds”, and the required time for the activation process in relation to the third update software D1 is “C (>B) seconds”. In the example of description of step SB10, it is assumed that A seconds+B seconds+C seconds, and B seconds+C seconds are the required time to which the current remaining electric power of the battery 21 is inapplicable.

In this example, the software update unit 271 decides, as the pieces of update software D1 that are allowed to make a transition to the activation process, the combination of the first update software D1 and the second update software D1 or the combination of the first update software D1 and the third update software D1.

In this example, in a case where the second information includes information indicating the application order between the first update software D1 and the second update software D1, the software update unit 271 decides the following combination. That is, the software update unit 271 decides the combination of the first update software D1 and the second update software D1 as the pieces of update software D1 that are allowed to make a transition to the activation process, and does not decide the combination of the first update software D1 and the third update software D1.

The software update unit 271 determines whether or not to make a transition to the activation process (step SB11).

Step SB11 will be described in detail.

In a case where the combination has been successfully decided in step SB10, the software update unit 271 determines to make a transition to the activation process. On the other hand, in a case where the combination has not been successfully decided in step SB10, the software update unit 271 determines not to make a transition to the activation process.

In a case where determination to make a transition to the activation process has been made in step SB11, the sum of required times for the activation process corresponding to the combination that has been decided in step SB10 is set as the actual required time for the activation process. For example, in a case where, in step SB10, the combination of the first update software D1 and the second update software D1 is decided and the sum of required times for the activation process corresponding to this combination is “A seconds+B seconds”, this “A seconds+B seconds” is set as the actual required time for the activation process.

Returning to the description of SB7, in a case where the software update unit 271 has determined that the current remaining electric power of the battery 21 is equal to or larger than the remaining electric power corresponding to the upper limit of the required time for the activation process (step SB7: YES), the software update unit 271 determines whether or not the sum of the required times for the activation process that has been acquired in step SB6 is longer than the upper limit of the required time for the activation process (step SB12).

In a case where the software update unit 271 has determined that the sum of the required times for the activation process that has been acquired in step SB6 is not longer than the upper limit of the required time for the activation process (step SB12: NO), the software update unit 271 determines to make a transition to the activation process (step SB13).

In a case where the process of step SB13 is performed, the sum of the required times for the activation process that has been acquired in step SB6 is set as the actual required time for the activation process.

In a case where the software update unit 271 has determined that the sum of the required times for the activation process acquired in step SB6 is longer than the upper limit of the required time for the activation process (step SB12: YES), the software update unit 271 decides the combination of the pieces of update software D1 that are allowed to make a transition to the activation process (step SB14).

In step SB14, the software update unit 271 decides the combination of the pieces of update software D1 so that the required time for the activation process does not become longer than the upper limit.

Next, the software update unit 271 determines to make a transition to the activation process (step SB15).

In a case where the process of step SB15 has been performed, the sum of required times for the activation process corresponding to the combination that has been decided in step SB14 is set as the actual required time for the activation process.

Next, description is provided about the operation of the case where the location of the vehicle 2 when the ignition power source has been turned off is the home location and the timing when the ignition power source has been turned off is the at-home time.

FIG. 6 is a flowchart showing the operation of the software update unit 271. The flowchart in FIG. 6 is the operation to be started in the case where the location of the vehicle 2 when the ignition power source has been turned off is the home location and the timing when the ignition power source has been turned off is the at-home time.

The software update unit 271 acquires, for each piece of update software D1 included in the second information, the required time for the activation process (step SC1).

Next, the software update unit 271 acquires the next ON time on the basis of the current remaining electric power of the battery 21 (step SC2).

Step SC2 will be described in detail.

The software update unit 271 refers to the relationship data 284 to acquire the next ON time. As described above, the relationship data 284 is data indicating the relationship between the home-location remaining electric power and the next ON time. Therefore, by referring to the relationship data 284, the software update unit 271 can acquire the next ON time according to the current remaining electric power of the battery 21.

The software update unit 271 determines whether or not the sum of required times for the activation process that has been acquired in step SC1 is longer than the acquired next ON time (step SC3).

In a case where the software update unit 271 has determined that the total sum of the required times for the activation process is not longer than the next ON time (step SC3: NO), the software update unit 271 determines whether or not the remaining electric power of the battery 21 corresponding to the sum of the required times for the activation process that has been acquired in step SC1 is larger than the current remaining electric power of the battery 21 (step SC4).

In a case where the software update unit 271 has determined that the remaining electric power of the battery 21 corresponding to the sum of the required times for the activation process that has been acquired in step SC1 is not larger than the current remaining electric power of the battery 21 (step SC4: NO), the software update unit 271 determines to make a transition to the activation process (step SC5).

In a case where the process of step SC5 has been performed, the sum of the required times for the activation process that has been acquired in step SC1 is set as the actual required time for the activation process.

In a case where the software update unit 271 has determined that the remaining electric power of the battery 21 corresponding to the sum of the required times for the activation process that has been acquired in step SC1 is larger than the current remaining electric power of the battery 21 (step SC4: YES), the software update unit 271 decides the combination of the pieces of update software D1 that are allowed to make a transition to the activation process (step SC6).

Step SC6 is performed similarly to step SB10.

Next, the software update unit 271 determines whether or not to make a transition to the activation process (step SC7).

Step SC7 will be described in detail.

In a case where the combination has been successfully decided in step SC6, the software update unit 271 determines to make a transition to the activation process. On the other hand, in a case where the combination has not been successfully decided in step SC6, the software update unit 271 determines not to make a transition to the activation process.

In a case where determination to make a transition to the activation process has been made in step SC7, the sum of required times for the activation process corresponding to the combination that has been decided in step SC6 is set as the actual required time for the activation process.

Returning to the description of SC3, in a case where the software update unit 271 has determined that the sum of the required times for the activation process is longer than the next ON time (step SC3: YES), the software update unit 271 decides the combination of the pieces of update software D1 that are allowed to make a transition to the activation process (step SC8).

Step SC8 will be described in detail.

In step SC8, the software update unit 271 decides the combination of the pieces of update software D1 so that the sum of the required times for the activation process is not longer than the next ON time and the activation process can be performed with the current remaining electric power of the battery 21.

The software update unit 271 determines whether or not to make a transition to the activation process (step SC9).

Step SC9 will be described in detail.

In a case where the combination has been successfully decided in step SC8, the software update unit 271 determines to make a transition to the activation process. On the other hand, in a case where the combination has not been successfully decided in step SC8, the software update unit 271 determines not to make a transition to the activation process.

In a case where determination to make a transition to the activation process has been made in step SC8, the sum of required times for the activation process corresponding to the combination that has been decided in step SC8 is set as the actual required time for the activation process.

As described above, in this embodiment, in the case where the location of the vehicle 2 when the ignition power source has been turned off is not the home location or in the case where the timing when the ignition power source has been turned off is not the at-home time, the required time for the activation process may be shortened relative to the upper limit. In addition, in this embodiment, in the case where the location of the vehicle 2 when the ignition power source has been turned off is the home location and the timing when the ignition power source has been turned off is the at-home time, the required time for the activation process may be extended relative to the upper limit within the range not being longer the next ON time.

### 5. Other Embodiments

The above-described embodiment merely shows an aspect thereof, and can be modified and applied as required.

In the above-described embodiment, the home location is exemplified as the “predetermined location”. However, the “predetermined location” is not limited to the home location, and may be, for example, the home of a relative of the user of the vehicle 2.

In the above-described embodiment, the at-home time is exemplified as the “predetermined time”. However, the “predetermined time” is not limited to the at-home time, and may be any time during which the vehicle 2 is not used for a relatively long time.

In other embodiments, if an upper limit is set for the required time for the activation process for each ECU 23 and the ECU 23 for which the required time for the activation process is longer than the upper limit exists, the required time for the activation process in this ECU 23 may be extended. Some ECUs 23 operate after the ignition power source is turned off. An example of this type of ECU 23 is the ECU 23 that controls a radiator fan. The ECU 23 that controls the radiator fan operates when the ignition power source is turned off in a case where driving with a heavy load on the engine is performed. The start timing of the activation process is delayed by this operating time. Therefore, in some cases, the end timing of the activation process may exceed the upper limit provided for each ECU 23. Therefore, based on statistical values of the occurrence frequency of the operation of the ECU 23 when the ignition power source is turned off and the time of the operation of the ECU 23 actually performed, the software update unit 271 determines whether or not the required time for the activation process can be extended for each ECU 23. For example, in a case where the occurrence frequency is equal to or lower than a threshold value and the time of the operation is also equal to or shorter than a threshold value, the software update unit 271 determines that the required time for the activation process of the ECU 23 can be extended. Alternatively, for example, in a case where the occurrence frequency is higher than the threshold value and the time of the operation is also longer than the threshold value, the software update unit 271 determines that the required time for the activation process of the ECU 23 cannot be extended. Alternatively, for example, in a case where the occurrence frequency is higher than the threshold value and the time of the operation is equal to or shorter than the threshold value, the software update unit 271 determines that the required time for the activation process of the ECU 23 can be extended in a case where variation in the time of operation is equal to or larger than a certain level. Alternatively, for example, in a case where the occurrence frequency is equal to or lower than the threshold value and the time of the operation is longer than the threshold value, the software update unit 271 determines that the required time for the activation process of the ECU 23 can be extended in a case where variation in the time of operation is equal to or larger than the certain level.

The processors 231, 270, and 300 may be composed of a plurality of processors or may be composed of a single processor. These processors may be hardware programmed to implement the functional units described above. In such case, these processors are implemented by, for example, an application specific integrated circuit (ASIC) or a field programmable gate array (FPGA).

The internal configuration of the vehicle 2 shown in FIG. 3 is an example, and the specific implementation is not particularly limited. In other words, hardware individually corresponding to each unit is not necessarily implemented, and it is of course possible to adopt a configuration in which a single processor executes a program to thereby achieve the functions of respective units. Furthermore, a part of the functions achieved by software in the above-described embodiment may be provided as hardware, or a part of the functions achieved by the hardware may be achieved by the software.

The operational step units shown in FIGS. 4 to 6 are obtained by dividing a process according to its main contents. The present invention is not limited by how to divide the process into units or how to name the divided units. The process may be further divided into more step units according to its contents. The process may also be divided so that one step unit includes more processes. The order of the steps may be changed as appropriate within a range that does not depart from the spirit of the present invention.

In a case where the system update method by the software update device 27 described above is implemented by using the processor 270, the program to be executed by the processor 270 can also be configured in the form of a recording medium or a transmission medium that transmits the program. That is, the control program 281 can also be achieved with the control program 281 recorded on a portable information recording medium. Examples of the information recording medium include magnetic recording media such as a hard disk, optical recording media such as a CD, and semiconductor storage devices such as a universal serial bus (USB) memory and a solid state drive (SSD), but other recording media can also be used.

### 6. Configurations Supported by the Above Embodiments

The above embodiments support the following configurations.

### Configuration 1

A software update system including: a vehicle including an electronic control unit; and a server device capable of communicating with the vehicle, wherein the vehicle includes a software update unit that performs update of software of the electronic control unit, and a battery that supplies electric power to the electronic control unit, and wherein the software update unit transmits first information inquiring presence or absence of information related to the update of the software to the server device, receives second information including update software from the server device, acquires, based on the second information received, a required time for an activation process of the update software, and determines, based on the required time acquired and remaining electric power of the battery, whether or not to make a transition to the activation process.

According to the software update system of Configuration 1, the transition determination to the activation process is made based on the acquired required time for the activation process and the remaining electric power of the battery. Therefore, the transition determination to the activation process can be made depending on whether or not the remaining electric power of the battery is sufficient for the actual required time for the activation process, which increases the possibility of transitioning to the activation process. Accordingly, the possibility of performing update of the software can be increased.

### Configuration 2

The software update system according to Configuration 1, wherein the second information includes a plurality of pieces of the update software, and the software update unit acquires the required time for each piece of the update software included in the second information, decides, based on the required time acquired and the remaining electric power of the battery, a combination of pieces of the update software that are allowed to make a transition to the activation process, and determines to make a transition to the activation process.

According to the software update system of Configuration 2, determination to make a transition to the activation process is made in a case where the combination of pieces of the update software that are allowed to make a transition to the activation process has been successfully decided. Therefore, the possibility of transitioning to the activation process can be increased. Accordingly, the possibility of performing update of the software can be further increased.

### Configuration 3

The software update system according to Configuration 2, wherein the software update unit decides, based on an order of applying pieces of the update software, the combination of pieces of the update software that are allowed to make a transition to the activation process.

According to the software update system of Configuration 3, the combination of pieces of update software can be decided by taking into account the order of applying pieces of the update software. Therefore, update of pieces of the software can be performed in the proper order and the possibility of performing the update of the software can be increased.

### Configuration 4

The software update system according to Configuration 1, wherein, in a case where a location of the vehicle at a predetermined time is a predetermined location, the software update unit sets the required time on the basis of the remaining electric power of the battery and a time until an ignition power source of the vehicle is turned on next time.

According to the software update system of Configuration 4, the required time for the activation process can be set in consideration of the remaining electric power of the battery and the time until the ignition power source is turned on next time. Therefore, the required time for the activation process can be set to be longer when the remaining electric power of the battery and the time until the ignition power source is turned on next time are enough. Accordingly, while suppressing the user of the vehicle from feeling discomfort with unavailability of the vehicle due to the activation process, it is possible to perform update of many pieces of software.

### Configuration 5

The software update system according to Configuration 4, wherein the software update unit learns relationship between the remaining electric power of the battery of the case where the location of the vehicle at the predetermined time is the predetermined location and the time until the ignition power source is turned on next time.

According to the software update system of Configuration 5, the required time for the activation process can be set in accord with the trend of the remaining electric power of the battery of the case where the location of the vehicle at the predetermined time is the predetermined location and the time until the ignition power source is turned on next time. Accordingly, it is possible to prevent the required time for the activation process from being set inappropriately for the time until the ignition power source is turned off next time.

### Configuration 6

A vehicle capable of communicating with a server device, the vehicle including: an electronic control unit; a software update unit that performs update of software of the electronic control unit; and a battery that supplies electric power to the electronic control unit, wherein the software update unit transmits first information inquiring presence or absence of information related to the update of the software to the server device, receives second information including update software from the server device, acquires, based on the second information received, a required time for an activation process of the update software, and determines, based on the required time acquired and remaining electric power of the battery, whether or not to make a transition to the activation process.

According to the vehicle of Configuration 6, the same effect as the software update system of Configuration 1 is achieved.

### Configuration 7

A software update device provided in a vehicle capable of communicating with a server device, the software update device including a software update unit that performs update of software of an electronic control unit owned by the vehicle, wherein the software update unit transmits first information inquiring presence or absence of information related to the update of the software to the server device, receives second information including update software from the server device, acquires, based on the second information received, a required time for an activation process of the update software, and determines, based on the required time acquired and remaining electric power of a battery that supplies electric power to the electronic control unit, whether or not to make a transition to the activation process.

According to the software update device of Configuration 7, the same effect as the software update system of Configuration 1 is achieved.

### Configuration 8

A software update method for performing update of software of an electronic control unit owned by a vehicle capable communicating with a server device, wherein, in the update of the software, the vehicle transmits first information inquiring presence or absence of information related to the update of the software to the server device, receives second information including update software from the server device, acquires, based on the second information received, a required time for an activation process of the update software, and determines, based on the required time acquired and remaining electric power of a battery that supplies electric power to the electronic control unit, whether or not to make a transition to the activation process.

According to the software update method of Configuration 8, the same effect as the software update system of Configuration 1 is achieved.

### Reference Signs List

1 software update system
2 vehicle
3 server device
4 base station
21 battery
22 control circuit
23 electronic control unit (ECU)
24 TCU
25 touch panel
26 GNSS unit
27 software update device
30 server control unit
31 server communication unit
231 processor
232 memory
233 software
270 processor
271 software update unit
280 memory
281 control program
282 home location data
283 at-home time data
284 relationship data
300 processor
310 memory
311 control program
D1 update software
MA storage area
NW communication network

1. A software update system comprising:
a vehicle including an electronic control unit; and
a server device capable of communicating with the vehicle,
wherein the vehicle includes
a software update unit that performs update of software of the electronic control unit, and
a battery that supplies electric power to the electronic control unit, and
wherein the software update unit
transmits first information inquiring presence or absence of information related to the update of the software to the server device,
receives second information including update software from the server device,
acquires, based on the second information received, a required time for an activation process of the update software, and
determines, based on the required time acquired and remaining electric power of the battery, whether or not to make a transition to the activation process.

2. The software update system according to claim 1, wherein
the second information includes a plurality of pieces of the update software, and
the software update unit
acquires the required time for each piece of the update software included in the second information,
decides, based on the required time acquired and the remaining electric power of the battery, a combination of pieces of the update software that are allowed to make a transition to the activation process, and
determines to make a transition to the activation process in a case where the combination of pieces of the update software that are allowed to make a transition to the activation process has been successfully decided.

3. The software update system according to claim 2, wherein
the software update unit decides, based on an order of applying pieces of the update software, the combination of pieces of the update software that are allowed to make a transition to the activation process.

4. The software update system according to claim 1, wherein,
in a case where a location of the vehicle at a predetermined time is a predetermined location, the software update unit sets the required time on the basis of the remaining electric power of the battery and a time until an ignition power source of the vehicle is turned on next time.

5. The software update system according to claim 4, wherein
the software update unit learns relationship between the remaining electric power of the battery of the case where the location of the vehicle at the predetermined time is the predetermined location and the time until the ignition power source is turned on next time.

6. A vehicle capable of communicating with a server device, the vehicle comprising:
an electronic control unit;
a software update unit that performs update of software of the electronic control unit; and
a battery that supplies electric power to the electronic control unit,
wherein the software update unit
transmits first information inquiring presence or absence of information related to the update of the software to the server device,
receives second information including update software from the server device,
acquires, based on the second information received, a required time for an activation process of the update software, and
determines, based on the required time acquired and remaining electric power of the battery, whether or not to make a transition to the activation process.

7. A software update device provided in a vehicle capable of communicating with a server device, the software update device comprising a software update unit that performs update of software of an electronic control unit owned by the vehicle,
wherein the software update unit
transmits first information inquiring presence or absence of information related to the update of the software to the server device,
receives second information including update software from the server device,
acquires, based on the second information received, a required time for an activation process of the update software, and
determines, based on the required time acquired and remaining electric power of a battery that supplies electric power to the electronic control unit, whether or not to make a transition to the activation process.

8. A software update method for performing update of software of an electronic control unit owned by a vehicle capable communicating with a server device,
wherein, in the update of the software,
the vehicle
transmits first information inquiring presence or absence of information related to the update of the software to the server device,
receives second information including update software from the server device,
acquires, based on the second information received, a required time for an activation process of the update software, and
determines, based on the required time acquired and remaining electric power of a battery that supplies electric power to the electronic control unit, whether or not to make a transition to the activation process.
